(19) United States
(12) Patent Application Publication
(10) Pub. No.: US 2005/0058189 A1
(43) Pub. Date: Mar. 17, 2005

(54) Method for training a receiving modem

(76) Inventors: Philip Chu Wah Yip, Austin, TX (US); Paul M. Brown JR., Austin, TX (US); Brian Scott Mirkin, Austin, TX (US)

Correspondence Address: DILLON & YUDELL LLP, 8911 NORTH CAPITAL OF TEXAS HWY, SUITE 2110, AUSTIN, TX, 78759, US

(21) Appl. No.: 10/663,628

(22) Filed: Sep. 16, 2003

(51) Int. Cl. H04B 1/38

(52) U.S. Cl. 375/222

(57) ABSTRACT

A method for training a receiving modem is disclosed. The receiving modem can be trained by a sending modem via a four-segment training procedure. During segment 1 training, the sending modem waits for silence on a transmission line between the sending modem and the receiving modem for 48 symbol intervals. Then, the sending modem performs segment 2 training by sending alternating AB symbols to the receiving modem for 64 symbol intervals. During segment 3 training, the sending modem sends CD symbols to the receiving modem for 64 symbol intervals in order to train an equalizer within the receiving modem. During segment 4 training, the sending modem continues to train the equalizer within the receiving modem by sending scrambled binary “1” symbols to the receiving modem for 48 symbol intervals. After a successful completion of the segment 4 training, the receiving modem can change to a data mode to begin detecting and receiving data from the sending modem.

### BACKGROUND OF THE INVENTION

1. Technical Field

The present invention relates to modems in general, and in particular to a method for synchronizing modems. Still more particularly, the present invention relates to an improved method for training a receiving modem.

2. Description of the Related Art

It is well-known in the art that modems can be utilized to perform data communications between data processing systems. Depending on a specific application, the data processing system can be a personal computer, a network server, a point-of-sale credit card reader, etc. Modems are typically capable of transmitting as well as receiving data. For ease of identification, a modem is denoted as a sending modem when transmitting data, and the modem is denoted as a receiving modem when receiving data.

Typically, a receiving modem employs timing recovery techniques to recover a symbol rate at which data are transmitted. A receiving modem also uses synchronization techniques to align the clock of the receiving modem with the clock of a sending modem. Synchronization signals are often transmitted near the beginning of a “handshaking” protocol during which a training procedure is performed within the receiving modem. Synchronization signals are also transmitted periodically during data transmission in order to maintain synchronization between the receiving modem and the sending modem.

During a handshaking protocol, a training procedure is performed by transmitting multiple training frames from the sending modem to the receiving modem. The training procedure is important because it ensures the receiving modem can compensate for the impairments on a telephone line before data transfer should begin. Thus, the training procedure needs to be long enough to ensure the receiving modem is able to recover all the transmitted data. However, if the training procedure is too long, it becomes the bottle-neck of a data transaction session, especially when the data transaction session is relatively short. For example, in point-of-sale applications, the data that need to be transmitted for a credit card transaction is usually much shorter than the data that needed to be transmitted for the training procedure. Consequently, it would be desirable to provide an improved method for training receiving modems such that optimal performances can be achieved.

### SUMMARY OF THE INVENTION

In accordance with a preferred embodiment of the present invention, a sending modem trains a receiving modem by performing a four-segment training procedure. During segment 1 training, the sending modem waits for silence on a transmission line between the sending modem and the receiving modem for 48 symbol intervals. Then, the sending modem performs segment 2 training by sending alternating AB symbols to the receiving modem for 64 symbol intervals. During segment 3 training, the sending modem sends CD symbols to the receiving modem for 64 symbol intervals in order to train an equalizer within the receiving modem. Specifically, the coefficients of the equalizer within the receiving modem are being modified in accordance with the received CD symbols from the sending modem during segment 3 training. During segment 4 training, the sending modem continues to train the equalizer within the receiving modem by sending scrambled binary “1” symbols to the receiving modem for 48 symbol intervals. Also during segment 4 training, a subset of the 48 estimated symbols from the equalizer within the receiving modem are descrambled for the purpose of accuracy verification. After a successful completion of the segment 4 training, the receiving modem can change to a data mode to begin detecting and receiving data from the sending modem.

All objects, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram of a data communication environment using pulse code modulation (PCM) based modems in which a preferred embodiment of the present invention is applicable;

FIG. 2 is a detailed block diagram of a modem, in accordance with a preferred embodiment of the present invention; and

FIG. 3 is a high-level logic flow diagram of a method for training a receiving modem, in accordance with a preferred embodiment of the present invention.

### DETAILED DESCRIPTION OF A PREFERRED EMBODIMENT

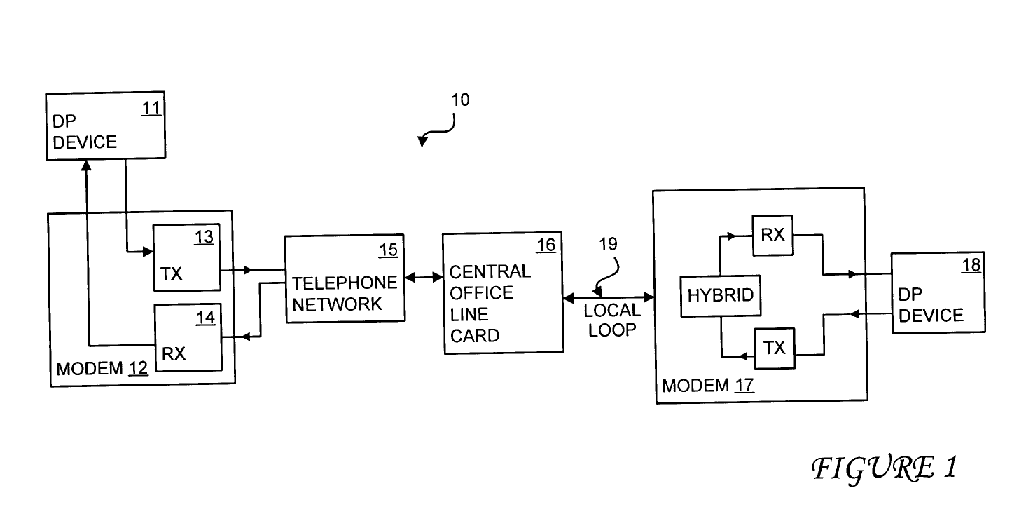

Referring now to the drawings and in particular to FIG. 1, there is depicted a block diagram of a data communication environment using pulse code modulation (PCM) based modems in which a preferred embodiment of the present invention is applicable. As shown, a data communication environment 10 includes a data processing device 11 coupled to a modem 12 and a data processing device 18 coupled to a modem 17. Data processing devices 11 and 12 can be a personal computer, a network server, a point-of-sale device or any type of data processing device that is well-known in the art. Data processing device 11 is connected to a telephone network 15 through a modem 12 having a transmitter 13 and a receiver 14. The connection between transmitter 13 and telephone network 15 is a digital connection having a data rate of approximately 64 kbps. Telephone network 15 is connected to a local loop 19 through a central office line card 16. Since the parameters of telephone network 15 and line card 16 are dictated by the specifications of a public telephone company, transmitter 13 needs to transmit digital data in a particular format to fully exploit its digital connection to telephone network 15. Those skilled in the art will appreciate that any known signal processing, coding, and decoding techniques related to, for example, μ-law signal point constellations, shell mapping, spectral control, equalizer training, and the like, can be utilized within central office line card 16. Local loop 19 is connected to data processing device 18 via modem 17. Similar to modem 12, modem 17 includes a transmitter and a receiver.

Modem 12 may format digital data for transmissions to modem 17, where the digital data is retrieved for use by data processing device 18. The data may be arranged into data symbols and encoded via any number of well-known techniques. The data symbols may then be further processed with spectral control (or other signal conditioning schemes) prior to being transmitted as one or more signal segments at a particular symbol rate to telephone network 15. Modem 17 eventually receives the data symbols and thereafter decodes the data to retrieve the original digital data. To function efficiently, modem 17 should be synchronized with modem 12. Modem 17 may include a timing recovery scheme that recovers the transmitted symbol rate and synchronizes the receiver at modem 17 with transmitter 13 within modem 12.

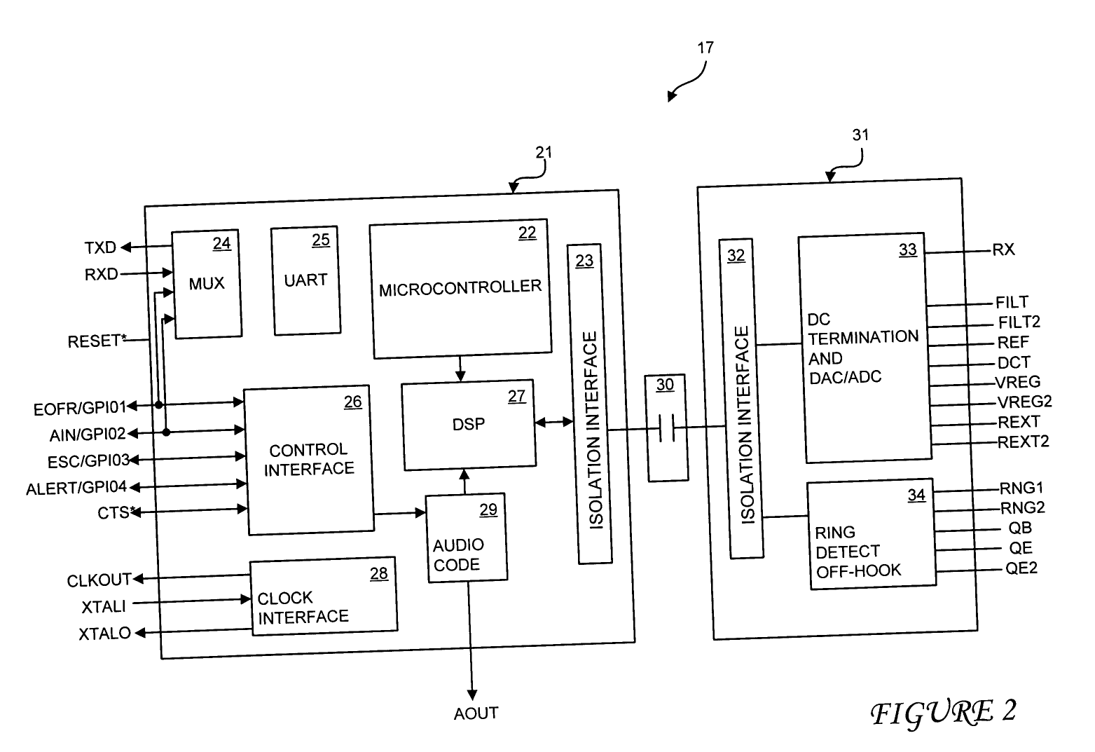

Both modem 12 and modem 17 can be either a sending modem or a receiving modem, depending on a specific application. Since modem 12 and modem 17 are functionally similar to each other, only modem 17 is further described in details. With reference now FIG. 2, there is depicted a detailed block diagram of modem 17, in accordance with a preferred embodiment of the present invention. As shown, modem 17 includes a system-side line-isolation module 21 and a line-side line-isolation module 31. System-side line-isolation module 21 and line-side line-isolation module 31 are coupled to each other via an isolation barrier 30. Isolation barrier 30 is preferably a capacitor. System-side line-isolation module 21 includes a microcontroller 22, an isolation interface 23, a multiplexer 24, an universal asynchronous receiver transmitter (UART) 25, a control interface 26, a digital signal processor (DSP) 27, a clock interface 28, and an audio coder-decoder (CODEC) 29.

System-side line-isolation module 21 includes a transmit pin TXD, a receive pin RXD, a reset pin RESET*, a clear-to-send pin CTS*, a clock output pin CLKOUT, crystal oscillator pins XTALI and XTALO, and an analog output pin AOUT. System-side line-isolation module 21 also includes four general purpose programmable input/output pins GPIO1, GPIO2, GPIO3, and GPIO4. Each of the above-mentioned four general purpose programmable input/output pins may be set up as analog in, digital in, or digital out pins, depending on user programming of pin functionality. For example, the GPIO1 pin may also function as an end of frame pin EOFR. The GPIO2 pin may provide an analog in pin AlN. The GPIO3 pin may function as an escape pin ESC for controlling command or data modes. The GPIO4 pin may function as an alert pin ALERT for signaling events such as an intrusion event.

UART 25 converts parallel bytes from microcontroller 22 into serial bits for transmission to and receipt from an external device through the transmit pin TXD and the receive pin RXD, respectively. UART 25 may operate in, for example, an 8-bit word format or a 9-bit word format for serial data transmission through the transmit pin TXD and/or the receive pin RXD.

In addition to signal processing, DSP 27 also functions as a data pump. Microcontroller 22 provides AT command decoding and call progress monitoring and may employ, for example, a 4-bit program word and an 8-bit data word. Clock interface 28 includes a clock generator that accepts a high-frequency (e.g., 4.9152 MHz) master clock input. Clock interface 28 also generates all the modem sample rates for supporting the modem standards designed into system-side line-isolation module 21. In addition, the clock generator within clock interface 28 provides a 9.6 kHz rate for audio playback.

Programming and control of system-side line-isolation module 21 is accomplished by sending appropriate commands through an serial interface. For example, commands may be sent by an external device that load internal registers within system-side line-isolation module 21 that control the operation and functionality of system-side line-isolation device 21.

Line-side line-isolation module 31 includes an isolation interface 32, a hybrid circuit 33 and a ring detect and off-hook circuit 34. Hybrid circuit 33 may include a DC termination circuit as well as an analog-to-digital converter (ADC) circuit and a digital-to-analog converter (DAC) circuit. Line-side line-isolation module 31 includes a receive input pin RX, filter pins FILT and FILT2, a reference pin REF, a DC termination pin DCT, voltage regulation pins VREG and VREG2, external resistor pins REXT and REXT2, ring pins RNG1 and RNG2 and transistor connection pins QB, QE and QE2.

Filter pins FILT and FILT2 set the time constant for the DC termination circuit. The reference pin REF may be connected to an external resistor to provide a high accuracy reference current. The DC termination pin DCT provides DC termination for a telephone phone line and an input for voltage monitors. Voltage regulation pins VREG and VREG2 may be connected to external capacitors to provide a bypass internal power supply. External resistor pins REXT and REXT2 provide real and complex AC termination. Ring pins RNG1 and RNG2 may be connected through capacitors to “tip” and “ring” to provide ring and caller ID signals across isolation barrier 30. Transistor connection pins QB, QE and QE2 may be connected to external bipolar hook-switch transistors.

If modem 17 from FIG. 1 is to be utilized as a receiving modem, then an adaptive equalizer needs to be provided within modem 17. Such adaptive equalizer is preferably implemented in software or firmware to be executed by DSP 27 within modem 17. In addition, a training procedure needs to be performed on the adaptive equalizer before modem 17 should receive data from a sending modem, such as modem 12 from FIG. 1. Basically, the training procedure generates approximately 40 to 60 coefficients for the adaptive equalizer in order to ensure that modem 17 can compensate for the impairments on a telephone line between modem 17 and modem 12 during data transmissions. The coefficients for the adaptive equalizer can be generated by the following equation:
wₙ(k+1)=w(k)+0.1/δ(rₖ)*e(k)*r(k−n)
where rₖ=input sample
   δ(rₖ)=input power of input sample
   Wₙ=equalizer coefficients
   e(k)=error between ideal symbol and equalizer output
   n=index of equalizer coefficients
   k=time index

To begin the training procedure, the sending modem initiates the transmission of a set of synchronizing signals to the receiving modem. The synchronizing signals are defined in Table 5/V.29 of the 9600 bits per second modem standardized for use on point-to-point 4-wire leased telephone-type circuits specification promulgated by the Telecommunication Standardization Sector of the International Telecommunication Union, the pertinent of which is incorporated by reference herein.

According to the above-mentioned specification, the synchronizing signals for all data signalling rates are divided into four segments, namely, segment 1, segment 2, segment 3 and segment 4. The number of symbol intervals in segment 1, segment 2, segment 3 and segment 4 are 48, 128, 384 and 48, respectively. Specifically, segment 1 of the synchronizing signals is simply waiting for silence for the duration of 48 symbol intervals. Segment 2 of the synchronizing signals includes alterations between a signal element A and a signal element B in the form of ABAB . . . ABAB for 128 symbol intervals.

Segment 3 of the synchronizing signals transmits a signal element C and a signal element D according to an equalizer conditioning pattern. The equalizer conditioning pattern is a pseudo-random sequence generated by a polynomial: 1+x⁻⁶+x⁻⁷. Element C is transmitted when the pseudo-random sequence contains a “0,” and element D is transmitted when the pseudo-random sequence contains a “1.” Segment 3 begins with the sequence CDCDCDC . . . according to the pseudo-random sequence and continues for 384 symbol intervals. Segment 4 of the synchronizing signals transmits a set of scrambled binary “1” symbols for 48 symbol intervals.

The analog signal received over the telephone line is typically demodulated and detected by digital techniques that involve analog to digital (A/D) conversion before reaching the adaptive equalizer. The sampling method of the A/D conversion can be used to assist the receiving modem to correctly detect a received symbol. In particular, the symbol boundaries are determined accurately by the receiving modem, and then the decision as to which symbol has been received is made at the peak of the symbol power where the accuracy of the decision is maximal and best modem performance can be achieved.

In accordance with a preferred embodiment of the present invention, only 64 symbol intervals are utilized to adjust the adaptive equalizer during the segment 3 training. In addition, the segment 4 scrambled binary “1” symbols are also utilized to adjust the adaptive equalizer during segment 4 training. By utilizing the segment 4 scrambled binary “1” symbols to train the adaptive equalizer, the training period for the adaptive equalizer can be effectively extended by 48 symbols without incurring additional overhead.

During the training procedure, a coarse timing algorithm is performed to determine the deviation from the ideal point at which the received signal should be sampled.

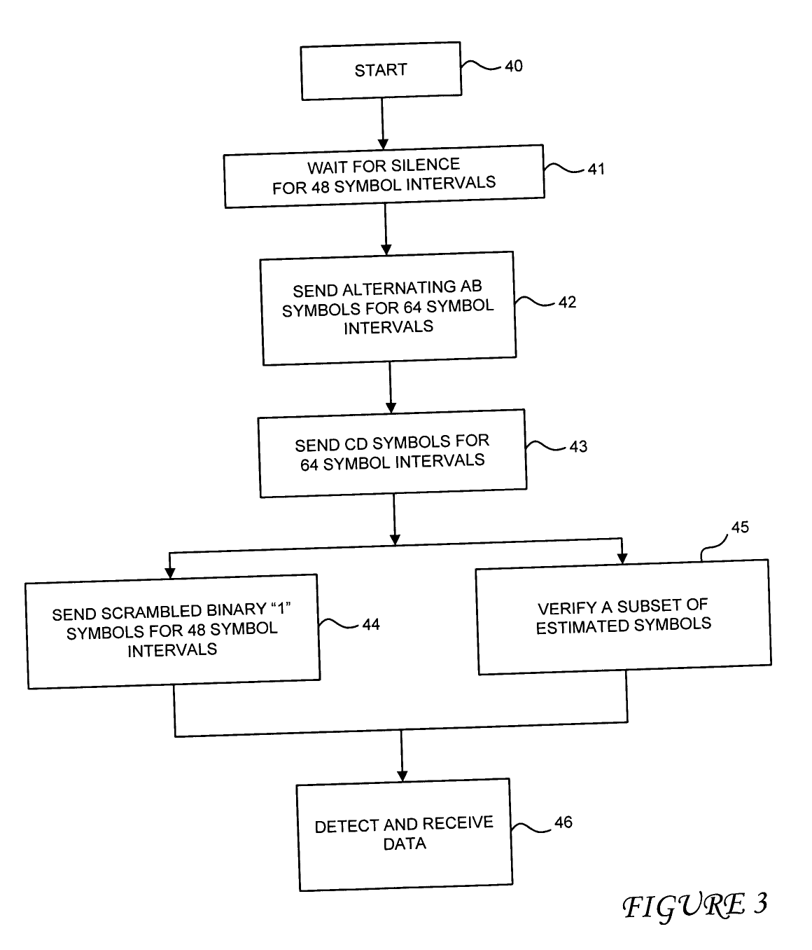

Referring now to FIG. 3, there is depicted a high-level logic flow diagram of a method for training a receiving modem, in accordance with a preferred embodiment of the present invention. Starting at blocking 40, the sending modem performs segment 1 training by waiting for silence for 48 symbol intervals, as shown in block 41. Then, the sending modem performs segment 2 training by sending alternating AB symbols for 64 symbol intervals, as depicted in block 42. Next, the sending modem performs segment 3 training by sending CD symbols for 64 symbol intervals, as shown in block 43, to generate corresponding coefficients for the adaptive equalizer within the sending modem. The sending modem then performs segment 4 training by sending scrambled binary “1” symbols for 48 symbol intervals, as depicted in block 44, to adjust the coefficients of the adaptive equalizer within the sending modem. A subset of the 48 estimated symbols generated from the 48 scrambled binary “1” symbols can be descrambled for the purpose of accuracy verification, as shown in block 45. Such accuracy verification can be performed in concurrence with the training step shown in block 44. For example, the last 8 to 10 of the 48 estimated symbols from the output of the adaptive equalizer can be utilized for verifying the accuracy of the adaptive equalizer. After a successful completion of the segment 4 training, the receiving modem changes to a data mode to begin detecting and receiving data from the sending modem, as depicted in block 46.

As has been described, the present invention provides an improved method for training receiving modems. With the present invention, it is feasible to make segment 3 training shorter than what is required in the published standard because of the information, such as the gain to use, equalizer coefficients, etc., gathered in the previous sessions. In addition, with the present invention, the training period for an adaptive equalizer can be extended without incurring additional overhead. As a result, a considerable time saving is achieved when timing adjustments for a given communication session are made via the usage of a relatively short training procedure.

It is also important to note that although the present invention has been described in the context of a fully functional modem, those skilled in the art will appreciate that the mechanisms of the present invention are capable of being distributed as a program product in a variety of forms, and that the present invention applies equally regardless of the particular type of signal bearing media utilized to actually carry out the distribution. Examples of signal bearing media include, without limitation, recordable type media such as floppy disks or CD ROMs and transmission type media such as analog or digital communications links.

While the invention has been particularly shown and described with reference to a preferred embodiment, it will be understood by those skilled in the art that various changes in form and detail may be made therein without departing from the spirit and scope of the invention.

1. A method for training a receiving modem, said method comprising:
performing segment 1 training by waiting for silence for a first set of symbol intervals;
performing segment 2 training by sending a plurality of alternating AB symbols for a second set of symbol intervals;
performing segment 3 training by sending a plurality of CD symbols for a third set of symbol intervals to generate a plurality of coefficients for an adaptive equalizer within said receiving modem; and
performing segment 4 training by sending a plurality of scrambled binary “1” symbols for a fourth set of symbol intervals to adjust said plurality of coefficients of said adaptive equalizer within said receiving modem.

2. The method of claim 1, wherein said first set of symbol intervals includes 48 symbol intervals.

3. The method of claim 1, wherein said second set of symbol intervals includes 64 symbol intervals.

4. The method of claim 1, wherein said third set of symbol intervals includes 64 symbol intervals.

5. The method of claim 1, wherein said fourth set of symbol intervals includes 48 symbol intervals.

6. The method of claim 1, wherein said performing segment 4 training further includes concurrently verifying a plurality of estimated symbols generated from a subset of said plurality of scrambled binary 1 symbols.

7. A computer program product residing on a computer usable medium for training a receiving modem, said computer program product comprising:
program code means for performing segment 1 training by waiting for silence for a first set of symbol intervals;
program code means for performing segment 2 training by sending a plurality of alternating AB symbols for a second set of symbol intervals;
program code means for performing segment 3 training by sending a plurality of CD symbols for a third set of symbol intervals to generate a plurality of coefficients for an adaptive equalizer within said receiving modem; and
program code means for performing segment 4 training by sending a plurality of scrambled binary “1” symbols for a fourth set of symbol intervals to adjust said plurality of coefficients of said adaptive equalizer within said receiving modem.

8. The computer program product of claim 7, wherein said first set of symbol intervals includes 48 symbol intervals.

9. The computer program product of claim 7, wherein said second set of symbol intervals includes 64 symbol intervals.

10. The computer program product of claim 7, wherein said third set of symbol intervals includes 64 symbol intervals.

11. The computer program product of claim 7, wherein said fourth set of symbol intervals includes 48 symbol intervals.

12. The computer program product of claim 7, wherein said program code means for performing segment 4 training further includes program code means for concurrently verifying a plurality of estimated symbols generated from a subset of said plurality of scrambled binary 1 symbols.

13. A modem comprising:
means for waiting for silence for a first set of symbol intervals;
means for receiving a plurality of alternating AB symbols for a second set of symbol intervals;
means for receiving a plurality of CD symbols for a third set of symbol intervals to generate a plurality of coefficients for an adaptive equalizer within said modem; and
means for receiving a plurality of scrambled binary “1” symbols for a fourth set of symbol intervals to adjust said plurality of coefficients of said adaptive equalizer.

14. The modem of claim 13, wherein said first set of symbol intervals includes 48 symbol intervals.

15. The modem of claim 13, wherein said second set of symbol intervals includes 64 symbol intervals.

16. The modem of claim 13, wherein said third set of symbol intervals includes 64 symbol intervals.

17. The modem of claim 13, wherein said fourth set of symbol intervals includes 48 symbol intervals.

18. The modem of claim 13, wherein said means for performing segment 4 training further includes means for concurrently verifying a plurality of estimated symbols generated from a subset of said plurality of scrambled binary 1 symbols.
